(19) United States
(12) Patent Application Publication
(10) Pub. No.: US 2008/0008223 A1
(43) Pub. Date: Jan. 10, 2008

(54) Device and Method for Detecting a Temperature Variation, in Particular for Detecting a Cryogenic Liquid Leakage

(76) Inventor: Gaetan Guillet, La Reid (BE)

Correspondence Address: AIR LIQUIDE;Intellectual Property, 2700 POST OAK BOULEVARD, SUITE 1800, HOUSTON, TX, 77056, US

(21) Appl. No.: 11/571,114

(22) PCT Filed: Jun. 21, 2005
(86) PCT No.: PCT/IB05/01744

§ 371 Date: Sep. 19, 2007

(30) Foreign Application Priority Data
Jun. 28, 2004 (BE) 2004/0317

(51) Int. Cl. G01K 3/10

(52) U.S. Cl. 374/4; 374/103

(57) ABSTRACT

The inventive device for detecting temperature variations comprises a hollow thermally conductive tube (1) for containing liquid (3), wherein said thermally conductive tube (1) consists of a first end (6,7) and a second end (7,6) one of which (6, 7) is connected to said sensor (4) and at least on of which (7,6) is sealed. Said device for detecting a temperature variations makes it possible to detect cryogenic, cold, hot and ultra-hot liquid leakage.

The present invention relates to a temperature change detection device comprising a means designed for determining a variation of a physical quantity resulting from a change in temperature, this means being connected to a detector for the measurement of said physical quantity. The invention also relates to an application of the device for the detection of temperature changes, in particular changes in temperature resulting from cryogenic liquid leakages.

Such a device is well known from the document EP 0 502 781 that describes a cryogenic liquid leakage detection device in which the means designed for determining the variation of a physical quantity resulting from a change in temperature is an optical fiber. This has the property of becoming opaque when it undergoes a change in temperature (from warm to cold) caused by a leakage of a cryogenic liquid occurring close to the latter. The optical fiber of the device described in the patent EP 0 502 781 is connected to the detector for the measurement of the physical quantity which, in this case, is a detector of variations in refractive index from the light emitted by the optical fiber when it becomes opaque. This detector requires the presence of lenses and of optical devices allowing the refractive indices to be measured. This device also implies the presence of a light source which is generally a laser.

Such a device has the drawback of being costly and cumbersome to implement. Indeed, the optical fiber is an expensive and delicate material, the light source comprises a laser which is also just as costly and the detector is also a complex, delicate and costly detector. Moreover, this device is not very flexible, only allows temperatures of the order of cryogenic temperatures to be detected and does not allow temperatures warmer than −60° C. to be readily detected, and which cannot therefore detect temperature changes due to leakages of warm liquids.

The aim of the invention is to overcome the drawbacks of the prior art by providing a device that allows temperature changes to be measured when it is configured for monitoring an installation over a given range of temperature values. The range of temperatures over which the device according to the invention may be used is very wide, varying from −269° C. to +3000° C., while at the same time maintaining high measurement precision and a simplicity of device and of method for the implementation of the device.

In order to solve this problem, according to the invention, a device is provided such as is indicated at the beginning in which said means comprises a hollow thermally-conducting tube designed to contain a fluid, said thermally-conducting tube comprising a first end and a second end, one of the two of which is connected to said detector and of which at least one of the two is closed.

This device is an extremely simple device in which the temperature changes are measured indirectly owing to the variation of a physical quantity of the fluid contained within the thermal conductor (volume, pressure, etc.). If the fluid is a liquid, in the case of a warming to be detected, for example in the case of an overflow of a hot liquid from a tank, the pressure will abruptly rise since the liquid contained within the tube will expand, or even vaporize. If, on the other hand, a leakage of a cryogenic liquid is to be detected, and if the thermally-conducting tube contains some kind of gas, for example CO₂, this will go from the gaseous state to the liquid state, resulting from the cooling, which will lead to a rapid drop in pressure.

Advantageously, the thermally-conducting tube is a metal tube or is made from a metal alloy. This allows a rapid warning of the indication of a leakage; indeed, the change of temperature on an external wall of the tube must be applied as quickly as possible to the fluid contained within the tube in order that this fluid can undergo its change of state. For this purpose, a metal tube or one made from a metal alloy is adequate, but any other mechanically resistant and thermally-conducting material is also suitable.

It goes without saying that the thermally-conducting tube will furthermore have to be fabricated with a material capable of withstanding the temperature of the fluid to be detected, that the tube material must be chemically compatible with the fluid to be detected and that the tube must be able to withstand a certain pressure.

In one advantageous embodiment, the fluid contained in the tube takes the form of a gas. Preferably, the gaseous fluid contained in said thermally-conducting tube is at a pressure different from atmospheric pressure. In a more preferable manner, the physical quantity to be measured will be the pressure and the device will comprise a manometer as pressure detector allowing the pressure existing in the thermally-conducting tube to be read and this pressure value will allow a change in temperature undergone by the thermal conductor to be detected.

In one particularly advantageous embodiment, the manometer is provided for generating a signal when the pressure of said fluid exceeds a pre-determined pressure threshold.

The manometer provided for generating a signal is for example a manometer connected to a relay; in this case, the emitted signal opens and closes the relay which respectively produces a signal interruption or transmission. According to one variant, the manometer can be an electronic manometer here generating an electronic signal. In other words, when the pressure of the fluid contained within the thermally-conducting tube falls, for example because a cryogenic liquid is flowing or leaking onto the latter, the manometer envisioned can be an ‘intelligent’ manometer such that, since the pressure has passed the critical value, a signal is emitted. This signal can be a directly audio or visual signal, because the manometer is equipped with the necessary device for this purpose, or else a signal requiring a later processing by emitters and/or processors.

The device according to the invention can also comprise a processor, connected to said detector, said processor also being provided in order to determine a pressure variation over time (ΔP/Δt), to compare said pressure variation over time (ratio ΔP/Δt) with a pre-determined value (ΔP/Δt)ₓ. This embodiment allows cases of leakages to the outside of the fluid contained in the thermally-conducting tube to be prevented from triggering the system and from being taken into account. Indeed, in the case where the fluid contained within the thermally-conducting tube is gaseous CO₂, it could be that the fluid leaks slowly to the outside, in which case the pressure variation over time will be a low value. On the other hand, if there is an abrupt decrease in temperature, the pressure will fall rapidly resulting from the change of state of the fluid from gaseous to liquid and, in this case, the pressure variation over time will be a much larger value. The processor can therefore be programmed so that it compares the pressure variation over time with a value of pressure variation over time which is only indicative of a change in temperature and which is not indicative of a leak in the thermally-conducting tube.

In addition, and in a very advantageous manner, the device comprises an alarm signal generator, connected to an output of said processor, said alarm signal generator being designed to emit at least one alarm signal.

Accordingly, with respect to what has just been stated hereinabove, the processor may send a signal to the alarm signal generator, in order that the latter generate an alarm, only in a real case of temperature change and not in the case of a leakage of the fluid contained within the thermally-conducting tube.

This embodiment allows the monitoring rounds to be avoided and allows the installation able to undergo a temperature change to be monitored by the device according to the invention remotely and/or automatically.

Advantageously, the end exposed to the temperature changes is said at least one closed one of the two ends of said thermally-conducting tube and the detector is connected to another end with respect to said at least one closed one of the two ends exposed to the temperature change.

In addition, the detector at said other end is situated within a region far removed from a region liable to be subject to temperature changes where said at least one closed one of the two ends is disposed, when said device is installed, the above-mentioned two ends being linked by means of said thermally-conducting tube.

This allows elements and materials to be used for the detector that do not need to withstand extreme conditions of temperature and pressure. These materials are therefore significantly less costly. Moreover, the fact that the detector can be moved further away allows it to be isolated from any potential electromagnetic or other interference that may be produced within the environment of industrial installations.

Other forms of embodiment of the device according to the invention are indicated in the appended claims.

The invention also relates to an application of the device for detecting temperature changes according to the invention for the detection of leakage of warm, cold and even cryogenic (ultra-cold) liquids.

Other features, details and advantages of the invention will become apparent from the non-limiting description presented hereinafter, which makes reference to the appended drawings.

FIG. 1 is a schematic illustration of the device according to the invention.

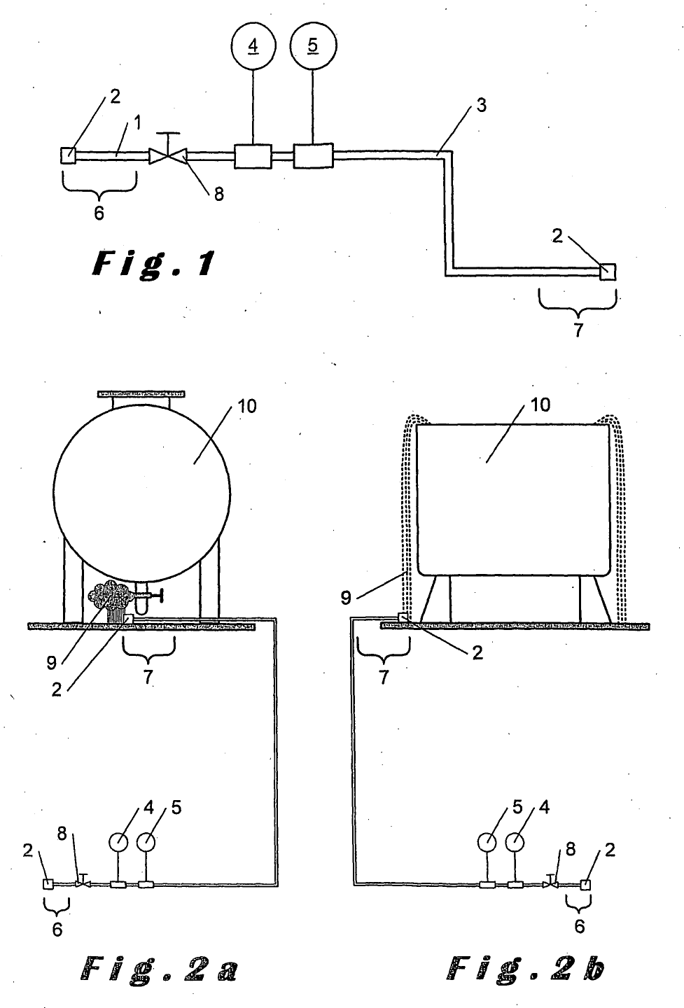

FIG. 2a is a schematic view of one embodiment of the invention and its application to the detection of cryogenic liquid leakages.

FIG. 2b is a schematic view of the same embodiment of the invention as in FIG. 2a and its application to the detection of an overflow of a tank containing a warm liquid.

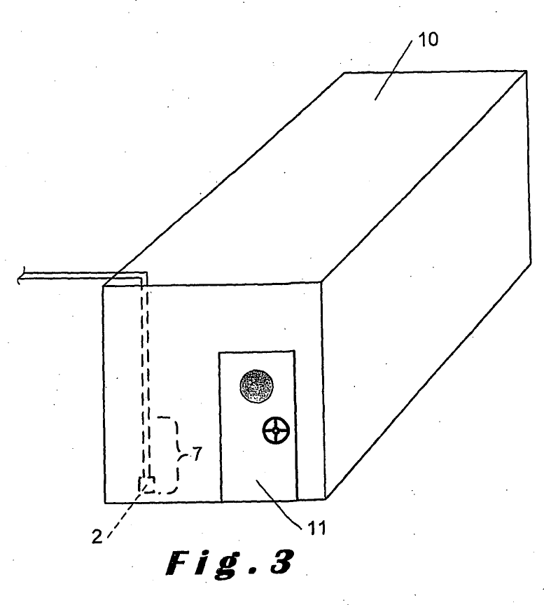

FIG. 3 is a schematic view of the same embodiment of the invention as in FIG. 2a or 2b, but whose application is different. The invention is used for detecting the warming of a cold room at −20° C.

FIG. 1 illustrates a preferred embodiment of the device according to the invention. This comprises a hollow thermally-conducting tube 1, one first end 7 of which is closed by a plug 2. The hollow thermally-conducting tube 1 contains a fluid 3, preferably in the form of a gas 3 whose pressure is measured by a manometer 4. Downstream of the manometer 4 could be another manometer 5 or a detector with its processor, where required, connected to an alarm signal emitter (not shown). The processor 5 could be programmed for emitting a signal in the case of abrupt pressure reduction if the zone to be monitored is liable to undergo an abrupt drop in temperature following a leakage of cryogenic liquid 9. Alternatively, the processor 5 could be programmed to emit a signal in the case of an abrupt increase in pressure corresponding, for example, to a covering of warm liquid over one of the ends 2 of the device. The emission of the signal will actually be carried out by comparison. In this particular case of the presence of a processor 5, by the comparison of the pressure variation over time (ratio ΔP/Δt) with a pre-determined value (ΔP/Δt)ₓ. The device also comprises an isolation tap or a valve 8. Upstream of the manometer 4, there is also a plug 2 (preferably of the biconical type) for closing the other end 6 of the hollow thermally-conducting tube 1.

Advantageously, the thermally-conducting tube surrounding the zone to be monitored must be filled with a gas 3 whose physical characteristics mean that, at the pressure at which it is confined within the tube 1, the gas 3 liquifies, or even solidifies, at the location where the thermally-conducting tube comes into contact with a cryogenic liquid 9.

As stated above, if a warm liquid 9 is to be detected, a fluid 3 in the liquid state will preferably be chosen and an increase in pressure due to the change of state toward a gaseous state of the liquid fluid is then detected. Here, it is understood that the nature of the fluid 3 will also depend on the normal temperature of the zone to be monitored (if it is exposed to the atmospheric conditions, in case of frost the liquefaction of the fluid must be avoided).

When the tube 1 is no longer brought into contact with the cryogenic liquid 9, the tube 1 warms up, together with the fluid 3 that it contains. The latter 3 will vaporize and the original pressure will be restored. The detection system again becomes automatic and naturally operational.

The principle used here for the case of the detection of cryogenic liquid 9, being the physical property that some gases possess of greatly reducing in volume when they liquefy or solidify.

Other forms of use are illustrated in FIGS. 2a, 2b and . These embodiments are based on exactly the same principle of operation. The only different feature being the change of temperature to be detected since the leakage of liquid to be detected, in the case of FIG. 2a, will result in an abrupt drop in temperature (leakage of cryogenic liquid 9 from a tank 10), an abrupt increase in temperature (overflow of warm liquid from a tank 10), or a smaller reduction in temperature due to the warming of a room 10 to −50° C. whose door 11 has accidentally been left open.

An example of gas that may be used for the detection of a cryogenic liquid leakage is CO₂. A table of values is presented hereinbelow that allows the liquefaction (condensation) temperature of this gas to be related to the pressure of the gas. This data is given by way of example and in no case may it be understood as limiting the invention to the use of CO₂. Numerous other gases could be used in this context, such as ammonia.

| P (bar) absolute | T° C. of condensation |
|---|---|
| 0.01 | −139 |
| 1 | −88 |
| 2 | −76 |

It will be understood that the present invention is in no way limited to the embodiments described hereinabove and that numerous modifications may be made to them without straying from the scope of the appended claims.

1-15. (canceled)

16. A temperature change detection device comprising a means designed for determining a variation of a physical quantity resulting from a change in temperature, this means being connected to a detector for the measurement of said physical quantity, wherein said means comprises a hollow thermally-conducting tube (1) designed to contain a fluid (3), said thermally-conducting tube (1) comprising a first end (6, 7) and a second end (7, 6), one of the two (6, 7) of which is connected to said detector (4) and of which at least one of the two (7, 6) is closed.

17. The temperature change detection device of claim 16, in which the thermally-conducting tube (1) is a metal tube or is made from a metal alloy.

18. The temperature change detection device of claim 16, in which the fluid (3) contained in the tube (1) takes the form of a gas.

19. The temperature change detection device of claim 18, in which the gaseous fluid (3) contained in said thermally-conducting tube (1) is at a pressure different from atmospheric pressure.

20. The temperature change detection device of claim 16, in which the physical quantity liable to vary resulting from said temperature change is the pressure.

21. The temperature change detection device of claim 16, in which a manometer (4) is provided for generating a signal when the pressure of said fluid (3) exceeds a predetermined pressure threshold.

22. The temperature change detection device of claim 16, also comprising a processor (5), connected to said detector (4), said processor (5) also being provided in order to determine a pressure variation over time (□P/□t), to compare said pressure variation over time (ratio □P/□t) with a pre-determined value (□P/□t)ₓ.

23. The temperature change detection device of claim 16 also comprising an alarm signal generator, connected to an output of said processor (5), said alarm signal generator being designed to emit at least one alarm signal.

24. The temperature change detection device of claim 16, in which said at least one signal is transmitted to an audio and/or visual alarm signal emitter designed to emit an alarm signal liable to be quickly noticed.

25. The temperature change detection device of claim 16, in which the end exposed to the temperature changes is said at least one closed one of the two ends (7, 6) of said thermally-conducting tube.

26. The temperature change detection device of claim 16, in which the detector (4) is connected to another end (6, 7) with respect to said at least one closed one of the two ends (7, 6) exposed to the temperature change.

27. The temperature change detection device of claim 26, in which the said detector at said other end (6, 7) is situated within a region far removed from a region liable to be subject to temperature changes where said at least one closed one of the two ends (7, 6) is disposed, when said device is installed, the above-mentioned two ends (6, 7) being linked by means of said thermally-conducting tube.

28. An application of the temperature change detection device of claims 16 to the detection of leakage of cryogenic liquids (9) (ultra-cold liquids, at a temperature below −50° C.).

29. An application of the temperature change detection device of claim 16 to the detection of leakage of warm liquids (9).

30. An application of the temperature change detection device of claim 16 to the detection of leakage of cold liquids (between 0 and −50° C.) (9).
